(19) United States
(12) Patent Application Publication
(10) Pub. No.: US 2002/0117604 A1
(43) Pub. Date: Aug. 29, 2002

(54) Measurement apparatus for dense wavelength division multiplexer devices

(75) Inventors: Brian E. Volk, Jefferson, MA (US); Robert S. Breidenthal, Bolton, MA (US); Robert N. Ross, Gardner, MA (US)

Correspondence Address: PEARSON & PEARSON, 10 George Street, Lowell, MA, 01852, US

(73) Assignee: Precision Optics Corporation

(21) Appl. No.: 10/016,170

(22) Filed: Nov. 30, 2001

Related U.S. Application Data
(60) Provisional application No. 60/251,987, filed on Dec. 6, 2000.

(51) Int. Cl. G01J 1/20; G01N 21/86

(52) U.S. Cl. 250/201.9; 250/548

(57) ABSTRACT

An optical testing apparatus for measuring the transmission characteristics of a DWDM filter. A first opto-mechanical lens assembly comprises a light emitter and a first optical axis which is angularly adjustable via a spherically shaped bearing surface pivoting about a specified first fixed point. A second opto-mechanical lens assembly comprises a light collector and a second optical axis which is also angularly adjustable via a spherically shaped bearing surface pivoting about a specified second fixed point whereby the second optical axis is positioned coaxially with respect to the first optical axis. The first optical axis and the second optical axis are coaxially aligned passing through a center of the DWDM filter positioned on a platen. A computer controlled measurement system for automatic testing of each of a plurality of DWDM filters comprises a tuneable laser system, a system control computer, a display, a light detector, a computer controlled xyz table and a measurement apparatus which includes an optical assembly having an optical axis which is angularly adjustable via a spherically shaped bearing surface pivoting about a fixed point.

This is a nonprovisional patent application claiming priority of provisional patent application Serial No. 60/251,987, filed Dec. 6, 2000.

### BACKGROUND OF THE INVENTION

1. Field of the Invention

This invention generally relates to apparatus for performing optical tests, and in particular to apparatus adapted for evaluating characteristics of optical devices such as dense wavelength division multiplexer (DWDM) filters.

2. Description of Related Art

A dense wavelength division multiplexer (DWDM) device allows a single fiber optic telecommunications line to segregate the output wavelengths of many different wavelength light signals that can be simultaneously passed through the same fiber line. Many of these devices use DWDM filters that are characterized by a narrow passband. The DWDM filter is a small optical glass component with an optical thin film coating. Accurately measuring the optical performance of such filters is critical. The generally accepted method of measuring filters is to precisely position the filter between an emitter and a detector. The emitter directs light having an appropriate bandwidth overlying the center frequency of the filter. The analysis of the output from the detector provides data from which the transmission characteristics of the filter can be determined. It has been found that such measurements are best achieved by directing collimated light along an axis that is normal to the plane of the filter. In addition, it has been found that a detector must account for any deviation of the light introduced by the filter itself.

Performing test measurements on individual DWDM filters is time consuming. A measurement apparatus holding a tray of a plurality of DWDM filters for automatic testing would speed-up measurement time and thereby reduce processing time and costs.

### SUMMARY OF THE INVENTION

Therefore it is an object of this invention to provide an optical testing apparatus that can precisely position a light axis with respect to an optical device under test.

Another object of this invention is to provide an optical test apparatus that is particularly adapted for measuring the characteristics of optical devices such as a dense wavelength division multiplexer (DWDM) filter.

It is still another object of this invention to provide a computer controlled measurement apparatus for determining the transmission characteristics of each of a plurality of DWDM filters.

These and other objects are accomplished by an apparatus for aligning an optical axis with respect to an optical device comprising a first opto-mechanical lens assembly having a first optical axis, the first optical axis being angularly adjustable via a spherically shaped bearing surface pivoting about a specified first fixed point, a second opto-mechanical lens assembly having a second optical axis, the second optical axis being angularly adjustable via a spherically shaped bearing surface pivoting about a specified second fixed point, the second optical axis being co-axial to the first optical axis, means for mounting the first opto-mechanical lens assembly co-axial with the second opto-mechanical lens assembly wherein the first fixed point and the second fixed point are nearly coincident and located at the optical device to be tested so that angular adjustments of either the first opto-mechanical lens assembly or the second opto-mechanical lens assembly do not translate the first optical axis and the second optical axis laterally, means for adjusting the second opto-mechanical lens assembly laterally, means positioned between the first opto-mechanical lens assembly and the second opto-mechanical lens assembly for receiving the optical device, and means for laterally centering the optical device about the first optical axis of the first opto-mechanical lens assembly and the second optical axis of the second opto-mechanical lens assembly. The optical device comprises a dense wavelength division multiplexer filter. The apparatus comprises means for providing a light source to the first opto-mechanical lens assembly. The apparatus comprises means for analyzing a light output from the second opto-mechanical lens assembly. The means for receiving the optical device comprises an intermediate xy table having a platen with a flat surface. The apparatus comprises means for applying a vacuum to fix the optical device onto the surface of the platen. The means for applying a vacuum to fix the optical device comprises a vacuum pump connected to a vacuum valve controlled by a valve controller. The platen comprises a plate having three layers including a metal layer attached to a base of the platen, an intermediate polished glass layer for supporting the optical device, and an upper glass layer that partially overlies the intermediate layer to position the optical device over a vacuum port through a center of the platen which is centered on the first optical axis of the first opto-mechanical lens assembly.

The objects are further accomplished by an optical filter measuring system comprising a measurement apparatus, the measurement apparatus comprises an optical assembly having an optical axis and a lens for directing a light beam along the optical axis, means, positioned along the optical axis and spaced apart from the optical assembly, for detecting the light beam after passing through an optical filter, means for providing a light source to the measurement apparatus, means, coupled to the light source providing means, for detecting reflected light from the measurement apparatus, a computer, connected to the measurement apparatus and the light source means, for controlling the measurement apparatus and the light source means and for processing measurement data for each optical filter being analyzed by the measurement apparatus, means coupled to the light beam detecting means for analyzing measurement data from the light beam detecting means, means, disposed adjacent to the optical assembly and the light beam detecting means, for positioning each of a plurality of optical filters between the optical assembly and the light detecting means for measurements in accordance with control signals from the computer, and means for generating and applying a vacuum under control of the computer to the optical assembly to position the optical filter in a correct position for measurement. The optical assembly comprises means for angularly adjusting the optical axis via a spherically shaped bearing surface pivoting about a fixed point. The means for angularly adjusting the optical axis comprises a pair of linear displacement adjustment mechanisms positioned preferably at a right angle with respect to each other and controlled by the computer to maximize reflected light, thereby establishing the optical axis normal to the filter. The optical filter includes a dense wavelength division multiplexer filter. The optical filter positioning means comprises an xyz table which moves in accordance with the control signals received from the computer. The light beam detecting means comprises an extended area light sensor. Each optical filter is positioned against an end portion of the optical assembly by means for providing a vacuum and computer control of the vacuum. The computer provides a display of test results calculated from the measurement data. The light source means comprises a variable frequency laser. The computer comprises a program for analyzing, displaying and storing the measurement data for each of the optical filters.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of an embodiment of a DWDM filter measurement apparatus incorporating this invention;

FIG. 2 is a block diagram of a system for performing optical measurements using the apparatus of FIG. 1;

FIG. 3 is a sectional elevation view of the measurement apparatus shown in FIG. 1;

FIG. 4 is a combination block diagram and perspective view of a computer controlled measurement system for DWDM filters incorporating the apparatus of this invention;

FIG. 5 is a block diagram of the system of FIG. 4 for performing optical measurements;

FIG. 6 is an enlarged view of the lower portion of the optical assembly of FIG. 5 showing an optical filter held by vacuum against an end cap of the optical assembly during measurements performed by the measurement system of FIG. 5;

FIG. 7 is a detail of a portion of the computer controlled DWDM filter measurement system shown in FIG. 4; and

FIGS. 8A and 8B in combination show a flow chart of a typical operating sequence for obtaining measurements with the apparatus of FIGS. 4 and 5.

### DESCRIPTION OF ILLUSTRATIVE EMBODIMENTS

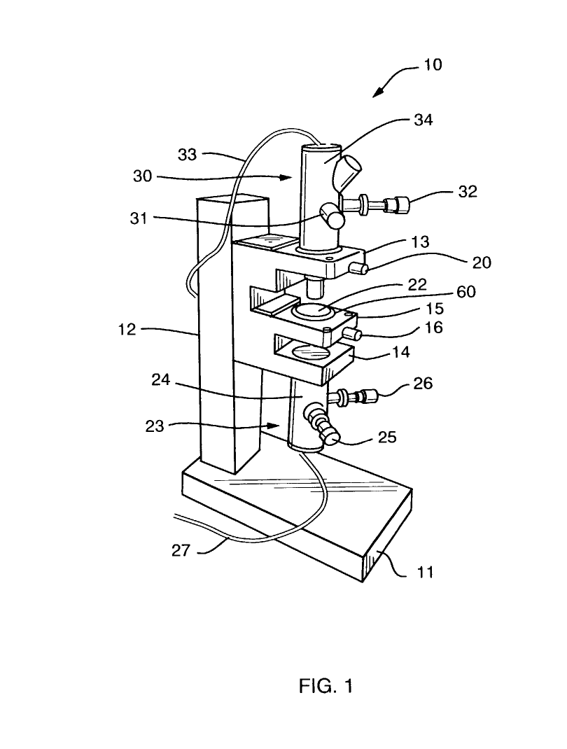

FIG. 1 depicts one embodiment of a measurement apparatus 10 that utilizes manually controlled structures for providing precise alignment. The measurement apparatus 10 includes a base 11 and a vertical post 12 that carries an upper xy table 13, a lower arm 14 and an intermediate xy table 15. The xy table 15 has manual adjusters 16 and 17 while the upper xy table 13 has manual adjusters 20 and 21. Manual adjusters 17 and 21 cannot be seen in FIG. 1 because they are located on the opposite side of the view shown. The intermediate xy table 15 also carries a platen 60 with a flat surface 22 that receives a DWDM filter for optical measurements. As more specifically disclosed later, a vacuum structure holds a DWDM filter on the flat surface 22 of platen 60 during the measurements.

The lower arm 14 carries a first optical mechanical lens assembly (or opto-mechanical lens assembly) 23 that is adjustable about an axis (i.e., a vertical axis in FIG. 1) by means of adjustment members 25 and 26. The optical housing 23 carries a light emitter that is particularly adapted for use with an optical spectrum analyzer or the like. A fiber optic cable 27 acts as a light conduit between a light source such as an optical spectrum analyzer and the emitter within the optical mechanical lens assembly 23.

The upper xy table 13 carries a second optical mechanical lens assembly (or opto-mechanical lens assembly) 30 with a housing 34 also aligned generally along the vertical optical axis. Adjustment mechanisms 31 and 32 accurately position the second optical mechanical lens assembly 30. An optical fiber 33 conveys light from the second optical mechanical lens assembly 30 to the optical spectrum analyzer.

With this structure, the xy table 15 aligns the flat surface with the optical axis defined by the optical mechanical lens assembly 23. The xy table 13 then aligns the optical assembly 30 with that same light axis. Thus, the manual adjusters associated with the xy tables are used to bring the optical axes of the optical mechanical lens assemblies 23 and 30 into coaxial alignment in the xy plane through a center of the surface 22 of platen 60.

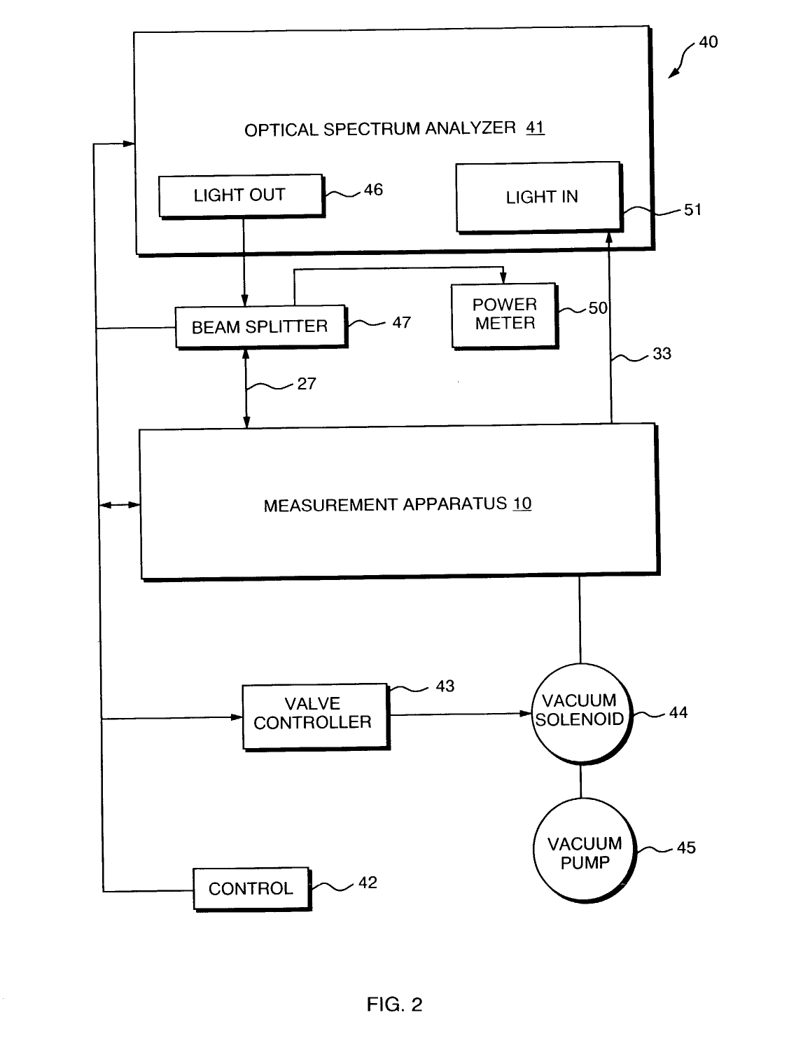

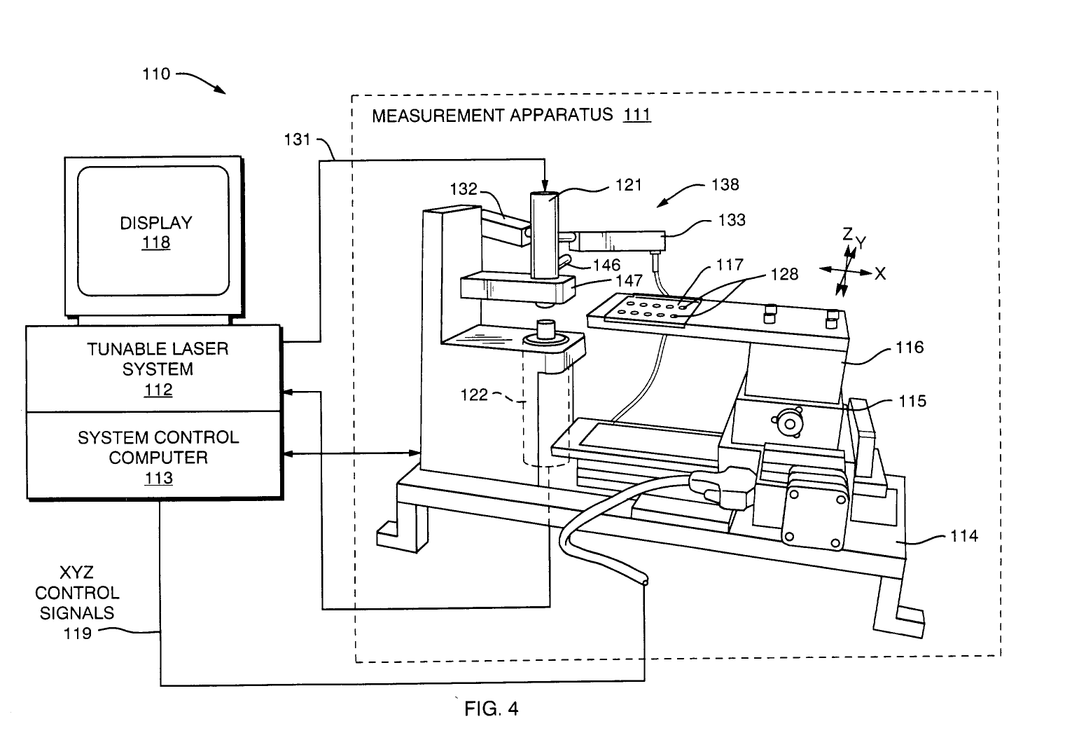

FIG. 2 shows a block diagram of a measurement system 40 using the apparatus 10 in FIG. 1. In this embodiment, the system 40 uses an optical spectrum analyzer 41 to analyze data from the measurement apparatus 10. An optional control 42 may be used to coordinate the operations of the optical spectrum analyzer 41, the measurement apparatus 10 and a valve controller 43 for a vacuum solenoid 44 that connects a vacuum pump 45 to the measurement apparatus 10. However, the apparatus shown in FIG. 1 is readily adapted for manual operation. FIG. 4 shows an alternate embodiment under computer control. The vacuum pump 45 may be embodied by Model MOA-P101-AA manufactured by GAST Manufacturing of Benton Harbor, Mich., and the vacuum solenoid 44 may be embodied by Model 01367-52 manufactured by Cole Palmer of Vernon Hills, Ill.

Referring to FIG. 1 and FIG. 2, a measurement begins by locating a sample DWDM filter on the surface 22 of platen 60. The control 42 or operator can then actuate a valve controller 43 to apply a vacuum to the measurement apparatus 10. The vacuum acts to fix the sample DWDM filter onto the surface 22.

When the optical spectrum analyzer 41 is energized, it generates light at a “light output” connector 46. An optical fiber or similar device conveys the light through a beam splitter 47 to the optical fiber 27. Light from the fiber 27 is directed through the measurement apparatus 10 to the sample DWDM filter. Light outside the passband reflects back along the fiber 27 through the beam splitter 47 to a power meter 50. An operator then can manipulate the adjustment mechanisms 25 and 26 in FIG. 1 to pivot the optical axis like a joystick until the power meter 50 indicates a maximum reflection. This occurs when the beam axis through the first optical mechanical lens assembly 23 is precisely normal to the plane of the sample DWDM filter.

Once this alignment is achieved, a further adjustment is made to the second opto-mechanical lens assembly 30 that contains a light receiver. The light passing through the sample DWDM filter is conveyed through the fiber 33 to a “light input” connection 51 on the optical spectrum analyzer 41. Now the adjustment mechanisms 31 and 32 can be manipulated until a maximum output is detected at the optical spectrum analyzer 41. When the maximum is achieved, the receiver in housing 34 is coaxial with the axis of the light that leaves the sample DWDM filter. This assures an accurate reading of the transmission characteristics of the sample DWDM filter. The optical spectrum analyzer 41 can then display a wave shape of the light the sample DWDM filter transmits that depicts amplitude as a function of wavelength. The optical spectrum analyzer 41 may be embodied by Model No. 86142B manufactured by AGILENT of Palo Alto, Calif.

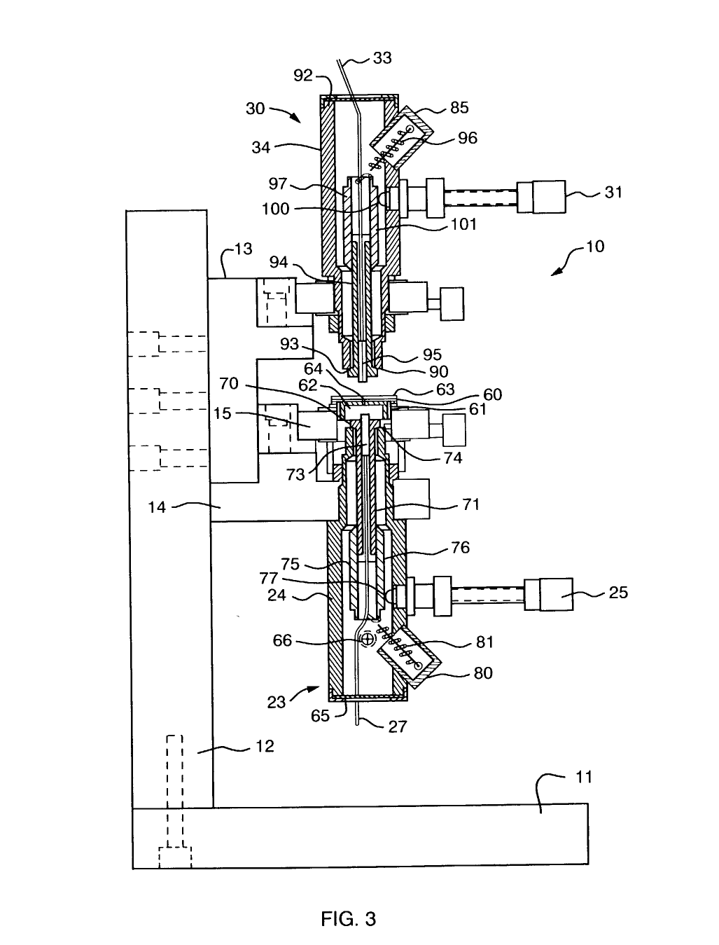

Referring to FIG. 3, a sectional elevation view of the measurement apparatus 10 is shown. In this embodiment, the xy table 15 carries a platen 60 with a base 61 that defines one end of a vacuum chamber 62. A plate 63 overlies the base 61. In a preferred embodiment, the plate has three layers. A metal layer attached to the base 61, an intermediate polished glass layer for supporting the sample DWDM filter and an upper glass layer that partially overlies the intermediate layer to facilitate positioning of the sample DWDM filter over a vacuum port 64 through the center of the platen 60.

The housing 24, supported by the lower arm 14 has a generally cylindrical shape with a vacuum seal 65 at the lower end and also has a vacuum port 66. As previously indicated, the vacuum port 66 will attach to the vacuum solenoid 44 in FIG. 2. As will now be apparent, when the valve controller 43 couples the vacuum pump 45 to the vacuum port 66, air pressure on the outer surface of the sample DWDM filter will clamp the sample DWDM filter to the platen 60. As will be apparent, individual components will include vacuum passages for enabling air to travel from the vacuum port 64 to vacuum port 66.

The housing 24 also includes a spherically shaped bearing surface 70 at its upper end adjacent the platen 60. The surface 70 supports a lens carrier 71 that carries a collimating lens such as GRIN lens 73 at its upper end. The fiber 27 connects to the collimating lens 73 after passing through a sealed portion of the housing 24. The upper end of the lens carrier 71 includes a spherical bearing surface 74 that complements and engages the spherical bearing surface 70. Consequently, the lens carrier 71 can pivot about a point, and this point is selected to be at the upper surface of a sample DWDM filter. This selection is made in order to allow the lens carrier 71 to pivot without inducing any translation in the housing 24.

A lower extension 75 on the lens carrier 71 includes two flat surfaces, only one flat surface 76 being shown in FIG. 3. The flat surface acts with the adjustment mechanism 25 that includes a driver 77 that can be moved axially, horizontally in FIG. 3, with precise displacements. A spring housing 80 mounted in the housing 24 carries a spring 81 that attaches to the bottom of the extension 75. The spring 81 acts along an axis that bifurcates the axes of the two adjustment mechanisms 25 and 26. The spring 81 biases the extension 76 against both the adjustment mechanisms 25 and 26. The spring 81 also produces a vertical force component to bias the lens carrier 71 and its bearing surface 74 against the spherical bearing surface 70.

Thus, manipulation of the adjustment mechanisms 25 and 26 can pivot the optical axis through the collimating lens 73 about a point on the surface of the DWDM filter. During calibration, this allows the collimating lens axis to be placed precisely normal to the plane of the sample DWDM filter because the maximum light reflects from the sample DWDM filter, back into the power meter 50, when that condition exists.

Still referring to FIG. 3, the upper optical mechanical lens assembly 30 has a similar construction, except that no vacuum components are required. The upper arm 13 carries the housing 34 that has a cylindrical shape and that terminates with a spherically shaped bearing surface 90 as its lower end, with a cap 92 at its upper end. The cap 92 merely acts as a dust cover.

The surface 90 bears against a complementary spherical bearing surface 93 on a lens carrier 94. Consequently the lens carrier 94 can pivot about a point and this point is selected to be at the surface of the sample DWDM filter. The lens carrier 94 carries a collimating lens 95. The fiber 33 couples the light collected by the collimating lens 95 to the optical spectrum analyzer 41 in FIG. 2.

A spring housing 85 at the upper end of the housing 34 provides a connection for a spring 96 that connects to an extension 97 from the lens carrier 94. The extension 97 includes flat surfaces for coacting with the adjustment mechanisms 31 and 32. FIG. 3 depicts the adjustment mechanism 31 with driver 100 that acts against a flat 101. Again, the spring axis bifurcates the adjustment mechanism axes, so the spring 96 biases the extension 97 against the drivers, such as the driver 100. In this optical mechanism, the spring 96 also provides a vertical force component that keeps the lens carrier 94 and its bearing surface 93 firmly seated against the spherical bearing surface 90.

During a measurement analysis and after the lower opto-mechanical lens assembly 23 has been calibrated, the upper optical assembly adjustment mechanisms 31 and 32 can be manipulated until the optical spectrum analyzer 41 displays a 5 maximum output within the passband. When this maximum is reached, the information supplied from the optical spectrum analyzer 41 accurately reflects the transmission characteristics of the sample DWDM filter.

Referring now to FIG. 4, an alternate embodiment of a computer controlled DWDM filter measurement system 110 is shown that comprises a measurement apparatus 111, a tuneable laser system 112 and a system control computer 113. This system 110 adapts the measurement apparatus 10 shown in FIGS. 1 through 3 to automated operation for cost effective testing of optical filters.

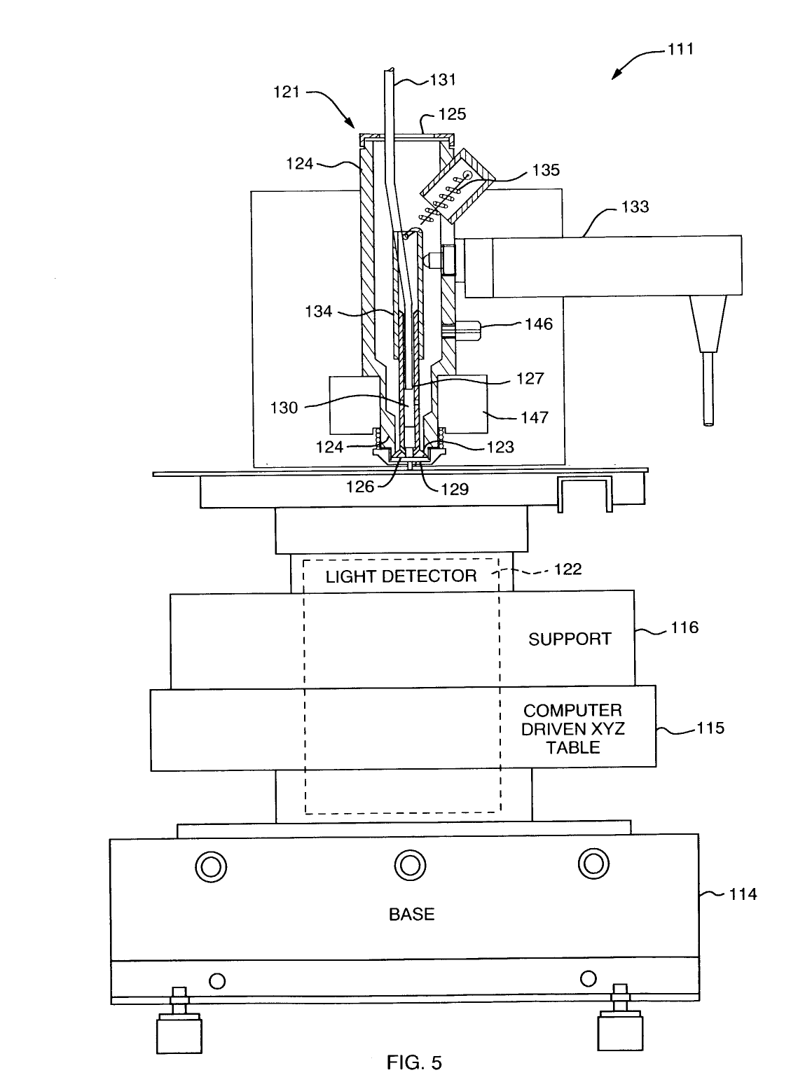

As shown in FIGS. 4 and 5, the measurement apparatus 111 includes a base 114 that supports two pieces of equipment. The first is a computer-driven xyz table 115 that carries a support 116 for receiving a tray 117 having a plurality of sample DWDM filters 128 carried in a matrix of known dimensions. The system control computer 112 contains an application program that includes, as one module, a program for precisely positioning each of the plurality of sample DWDM filters 128 for analysis in sequence. The second piece of equipment is an optical measurement apparatus 138 that includes a support arm 147 with an optical assembly 121 and a base support that carries a light detector 122.

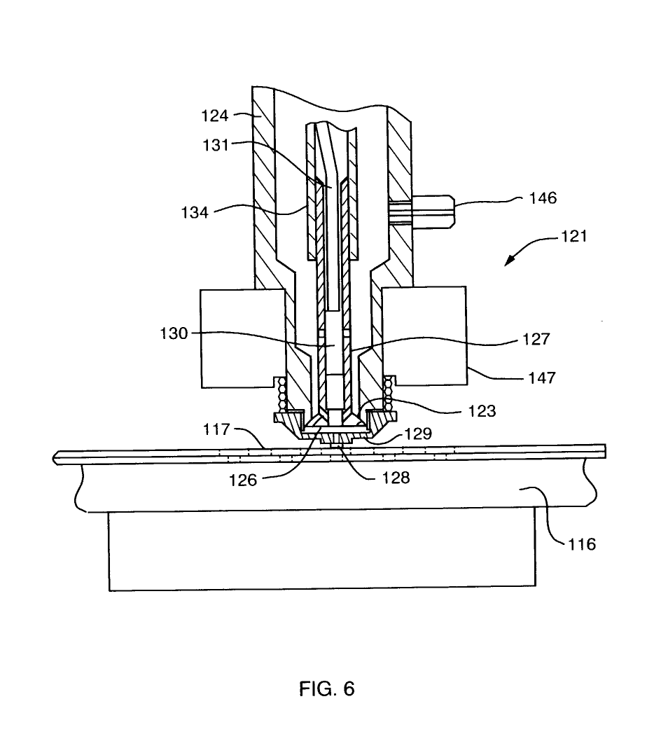

Still referring to FIG. 5 and also FIG. 6 which shows an enlarged view of the lower portion of optical assembly 121 having the DWDM filter held by vacuum against an end cap 129 of the optical assembly 121 during a measurement, the optical assembly 121 has the same basic construction as the opto-mechanical lens assembly 23 in FIGS. 1 and 3 including vacuum port 146 and seals. That is, the optical assembly 121 includes a cylindrical housing 124 that terminates with a spherically shaped bearing surface 123 at its lower end and with a cap or cover 125 at its upper end.

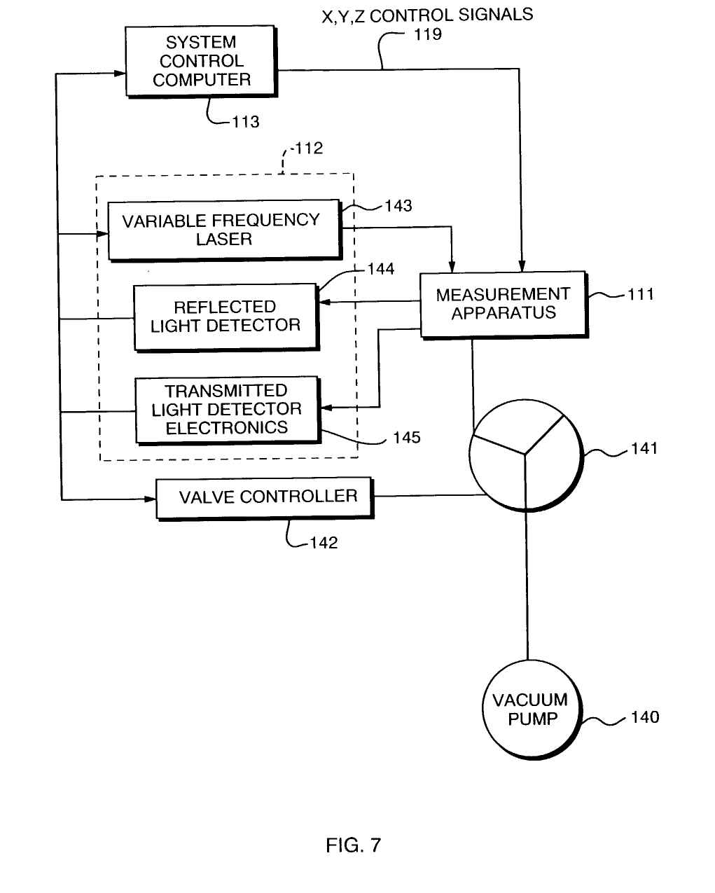

The surface 123 bears against a complementary spherical bearing surface 126 on a lens carrier 127. The lens carrier 127 carries a lens 130 for directing a laser beam along a vertical axis. A fiber 131 connects from the lens 130 to the laser source through a beam splitter (not shown) to couple laser energy to one of the sample DWDM filters 128 being tested. Reflected light from the sample DWDM filter 128 passes back through the fiber 131 to the reflected light detector 144 (FIG. 7) in the tuneable laser system 112 to determine the power of the reflected energy.

In this computer controlled embodiment, adjustment mechanisms 132 and 133 of the optical assembly 121, preferably positioned at a right angle to each other, act on an extension 134 from the lens carrier 127 against a force provided by a spring 135 that biases the extension 134 against the adjustment mechanisms 132 and 133. The spring 135 also provides a vertical force component that keeps the lens carrier 127 and bearing surface 126 firmly seated against the spherical bearing surface 123. As a further feature, each of the adjustment mechanisms 132 and 133 are computer-driven linear displacement devices. This eliminates any requirement for manual adjustments and facilitates the automation of the testing process.

The light detector 122 located below the optical assembly 121 may be embodied by an extended area light sensor Model No. 81624A manufactured by AGILENT of Palo Alto, Calif. The light detector sensors the light passing through the DWDM filter 128 being tested and sends the light to the transmitted light detector electronics 145 of the tuneable laser system 112 where transmitted modulation data is analyzed.

Referring to FIG. 7, a simplified block diagram is shown of the computer controlled measurement system of FIG. 4. The system control computer 113 generates xyz control signals 119 to control the position of the xyz table 115. The system control computer 113 may be embodied by a PC computer having a 1.0 GHz processor and a monitor running Windows 95 (or later version) operating system, such as is manufactured by Hewlett Packard of Palo Alto, California and many other computer manufacturers. The xyz table 115 may be embodied by the following components manufactured by Newport Corp. of Irvine, Calif.: Model VZM80MS1 for z axis, Model VTM150PP1H2 for x-axis, Model VTM150PP1HL for the y-axis, and a Model CMA-12PP tip/tilt head. The system control computer 113 controls vacuum supplied by a vacuum pump 140 through a valve 141 under supervision of a valve controller 142. In the present embodiment, for example, the housing 124 in FIG. 5 is vacuum tight and the bottom cap 129 provides a registration surface against which the sampled DWDM filter 128 is held. The vacuum pump 140 provides a method of partially raising one of the sample DWDM filters 128 from a tray 117 to contact with bottom cap 129 as shown in FIG. 6.

The tuneable laser system 112 includes a variable frequency laser 143, a reflected light detector 144, and a transmitted light detector electronics 145. The variable frequency laser 143 provides a time sequence of laser frequencies across a spectral bandwidth which includes the passband of the sampled DWDM filters 128. The transmitted light detector 122 of FIG. 5 receives the light output of the filter at those different frequencies and provides the transmission modulation data to the tuneable laser system 112. The tuneable laser system 112 may be embodied by a laser system Model 8164A manufactured by AGILENT of Palo Alto, Calif. comprising a laser module, Model 81682A, a power sensor, Model 81632A, for embodying the reflected light detector 144, and an electronics interface module, Model 81618A, to interface with the light detector 122 previously described.

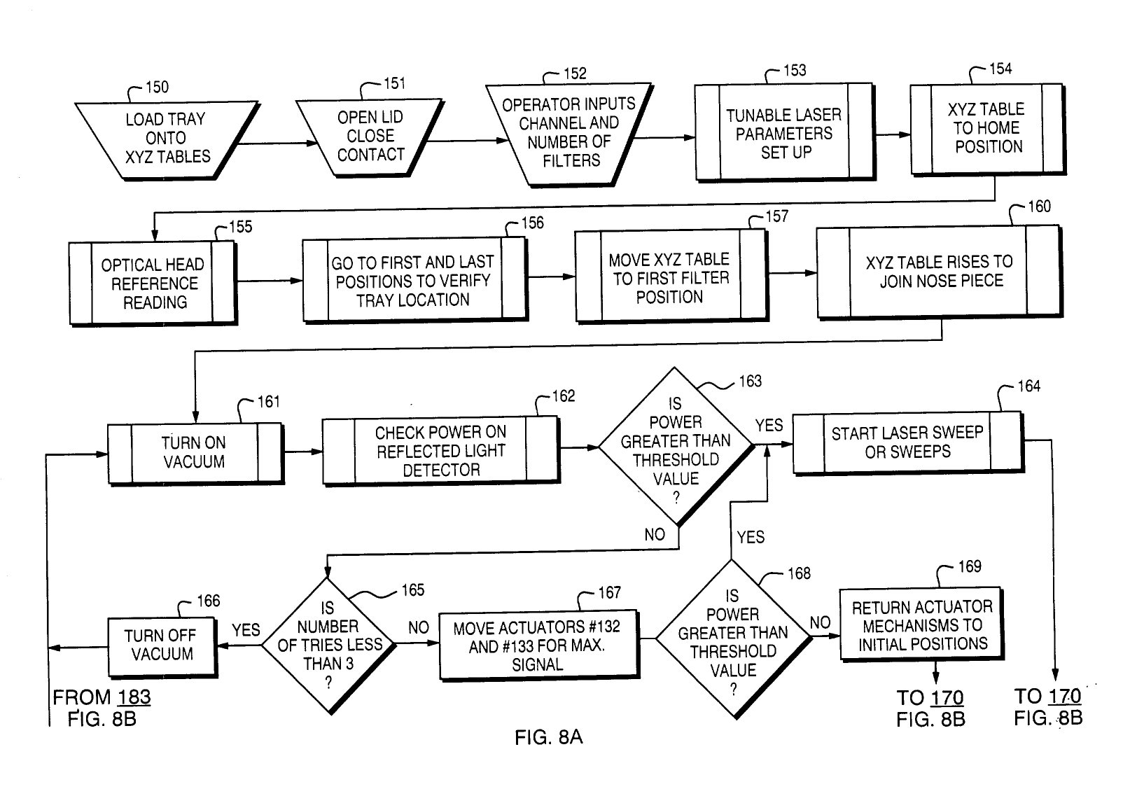

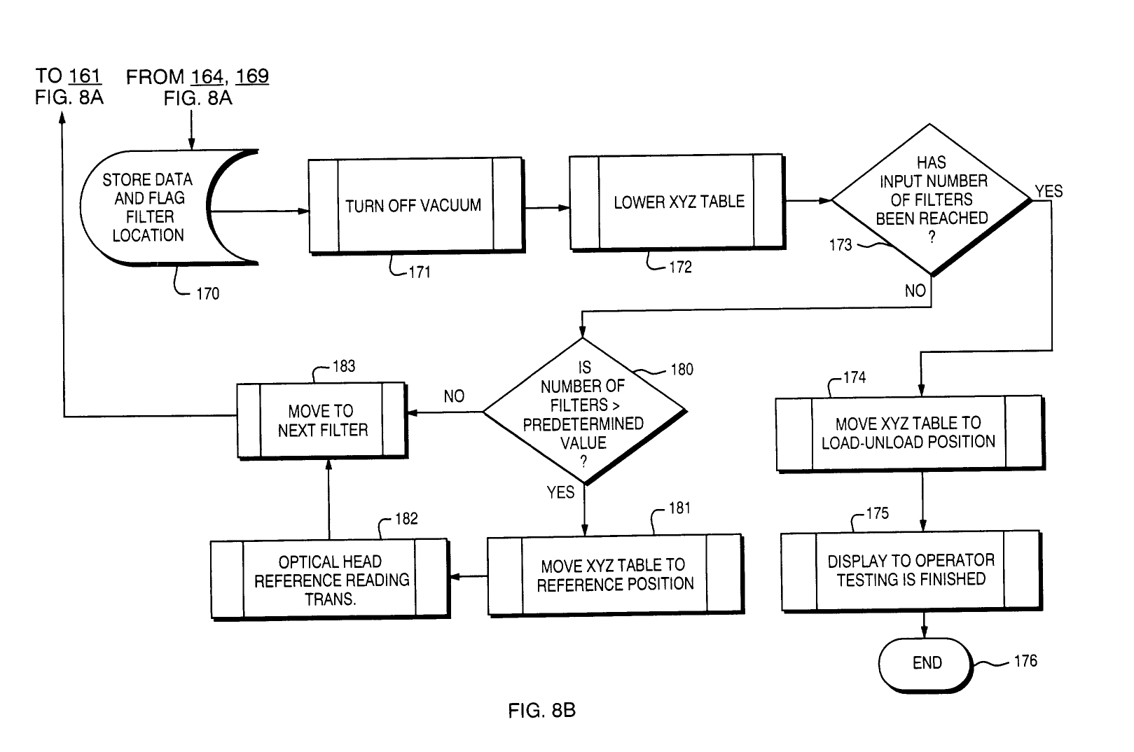

Referring to FIG. 8A and FIG. 8B, a flow chart is shown for performing the operating sequence to obtain optical filter measurements with the computer controlled system 110 shown in FIGS. 4-7. At step 150 the system 110 requires a tray 117 to be loaded onto the xyz table support 116. Step 151 represents some preliminary actions for assuring that the tray 117 carrying the sample DWDM filters 128 is accessible for the analysis. In step 152 the controller 113 requests the operator to identify information about certain inputs including desired measurement wavelength, the number of filters to be analyzed and filter identity. A module 153 then uses this information to establish a list of laser parameters for controlling the tunable laser system 112. Module 154 moves the xyz table 115 to a home position to calibrate a starting position. Module 155 takes a laser power reference reading. Step 156 then positions the xyz table 115 at first and last positions which are diagonally opposite to verify proper alignment in the xy plane. Step 157 moves the xyz table 115 to a first filter position and step 160 provides an optional elevation of the xyz table 115 into a final measurement position.

At this point a first sampled DWDM filter 128 is now positioned to start measurement. Step 161 activates the vacuum pump 140 and closes the valve 141 to generate a vacuum and pick up the selected sample DWDM filter 128. In step 162, the reflected light detector 144 then begins to monitor the reflected energy outside the passband from the DWDM filter 128. If step 163 determines that power is greater than a threshold valve, it is assumed that the angular alignment of the optical assembly 121 is such that the optical beam strikes the surface of the sample DWDM filter 128 at exactly right angles to the plane of the filter 128. In that case control passes to step 164 to begin a measurement. Otherwise, control passes to step 165. If no reflection is detected by step 162, step 163 transfers control to step 165 which turns off the vacuum pump 140 and then returns to step 161 thereby to recycle through steps 161 and 162. This is tried a number of times, for example three times, and is used in an attempt to reseat the sample DWDM filter 128 properly on the bottom cap 129 of the optical assembly 121.

After the predetermined number of tries, step 165 transfers control to step 167 which implements a search program to adjust the actuator mechanisms 132 and 133 (in FIG. 5) to a new position or positions. Then step 168 determines if the power has exceeded the threshold during this process. If it has, control passes back to step 164. Otherwise control passes to step 169 that moves the actuator mechanisms 132 and 133 to their initial positions. When either steps 165 and 169 have been completed, step 170 stores data about the individual filter 128. Step 171 then turns off the vacuum and, if necessary, step 172 lowers the xyz table 115. Step 173 then determines if all the filters have been analyzed. If they have, step 174 moves the xyz table 115 to an unload position; step 175 announces the completion of testing to an operator and terminates the program at step 176.

If additional sample DWDM filters 128 need to be analyzed, control passes from step 173 to step 180. In step 180, if the number of filters has reached another predetermined value, step 181 moves the xyz table 115 to a reference position. Control then passes to step 182 that obtains a reference reading before transferring control to step 183 that causes the xyz table 115 to move to the next DWDM filter 128. If the test of step 180 is not met, then control passes directly to step 183 to test a next filter 128.

As will be apparent from the foregoing description, each of the two embodiments has one common aspect, namely the construction of the optical assembly and particularly the mechanism for producing an angular adjustment. In both embodiments the adjustable members ride on a spherical surface, they move like a joystick. In both embodiments the center of rotation for each of those mechanisms is the surface of the sampled DWDM filter 128 being analyzed. Steps 163, 165, 167 and 168 provide a method for assuring that the optical assembly 121 is in a proper perpendicular orientation with respect to the sampled DWDM filter 128. Steps 180, 181, 182 then assure the system is correctly referenced in order to properly normalize transmission characteristics.

As will be apparent during each of these operations the system control computer 113, particularly when implemented as a data processing system, can record significant data about each DWDM filter analysis that can be useful in establishing optical transmission quality for such DWDM filters 128.

Each of these two embodiments have been disclosed in terms of specific structures and specific control systems and processes. Other structures and processes could be substituted for many of those specifically disclosed processes and mechanisms. Therefore, it is the intent of the appended claims to cover all such variations and modifications as come within the true spirit and scope of this invention.

What is claimed as new and desired to be secured by Letters Patent of the United States is:

1. An apparatus for aligning an optical axis with respect to an optical device comprising:
a first opto-mechanical lens assembly having a first optical axis, said first optical axis being angularly adjustable via a spherically shaped bearing surface pivoting about a specified first fixed point;
a second opto-mechanical lens assembly having a second optical axis, said second optical axis being angularly adjustable via a spherically shaped bearing surface pivoting about a specified second fixed point, said second optical axis being co-axial to said first optical axis;
means for mounting said first opto-mechanical lens assembly co-axial with said second opto-mechanical lens assembly wherein said first fixed point and said second fixed point are nearly coincident and located at said optical device to be tested so that angular adjustments of either said first opto-mechanical lens assembly or said second opto-mechanical lens assembly do not translate said first optical axis and said second optical axis laterally;
means for adjusting said second opto-mechanical lens assembly laterally;
means positioned between said first opto-mechanical lens assembly and said second opto-mechanical lens assembly for receiving said optical device; and
means for laterally centering said optical device about said first optical axis of said first opto-mechanical lens assembly and said second optical axis of said second opto-mechanical lens assembly.

2. The apparatus as recited in claim 1 wherein said optical device comprises a dense wavelength division multiplexer filter.

3. The apparatus as recited in claim 1 wherein said apparatus comprises means for providing a light source to said first opto-mechanical lens assembly.

4. The apparatus as recited in claim 3 wherein said apparatus comprises means for analyzing a light output from said second opto-mechanical lens assembly.

5. The apparatus as recited in claim 1 wherein said means for receiving said optical device comprises an intermediate xy table having a platen with a flat surface.

6. The apparatus as recited in claim 5 wherein said apparatus comprises means for applying a vacuum to fix said optical device onto the surface of said platen.

7. The apparatus as recited in claim 6 wherein said means for applying a vacuum to fix said optical device comprises a vacuum pump connected to a vacuum valve controlled by a valve controller.

8. The apparatus as recited in claim 5 wherein said platen comprises a plate having three layers including a metal layer attached to a base of said platen, an intermediate polished glass layer for supporting said optical device, and an upper glass layer that partially overlies said intermediate layer to position said optical device over a vacuum port through a center of said platen which is centered on said first optical axis of said first opto-mechanical lens assembly.

9. An optical filter measuring system comprising:
a measurement apparatus, said measurement apparatus comprises an optical assembly having an optical axis and a lens for directing a light beam along said optical axis;
means, positioned along said optical axis and spaced apart from said optical assembly, for detecting said light beam after passing through an optical filter;
means for providing a light source to said measurement apparatus;
means, coupled to said light source providing means, for detecting reflected light from said measurement apparatus;
a computer, connected to said measurement apparatus and said light source means, for controlling said measurement apparatus and said light source means and for processing measurement data for each optical filter being analyzed by said measurement apparatus;
means coupled to said light beam detecting means for analyzing measurement data from said light beam detecting means;
means, disposed adjacent to said optical assembly and said light beam detecting means, for positioning each of a plurality of optical filters between said optical assembly and said light detecting means for measurements in accordance with control signals from said computer; and
means for generating and applying a vacuum under control of said computer to said optical assembly to position said optical filter in a correct position for measurement.

10. The optical filter measuring system as recited in claim 9 wherein said optical assembly comprises means for angularly adjusting said optical axis via a spherically shaped bearing surface pivoting about a fixed point.

11. The optical filter measuring system as recited in claim 10 wherein said means for angularly adjusting said optical axis comprises a pair of linear displacement adjustment mechanisms positioned preferably at a right angle with respect to each other and controlled by said computer to maximize reflected light, thereby establishing said optical axis normal to said filter.

12. The optical filter measuring system as recited in claim 1 where said optical filter includes a dense wavelength division multiplexer filter.

13. The optical filter measuring system as recited in claim 9 wherein said optical filter positioning means comprises an xyz table which moves in accordance with said control signals received from said computer.

14. The optical filter measuring system as recited in claim 9 wherein said light beam detecting means comprises an extended area light sensor.

15. The optical filter measuring system as recited in claim 9 wherein each optical filter is positioned against an end portion of said optical assembly by means for providing a vacuum and computer control of said vacuum.

16. The optical filter measuring system as recited in claim 9 wherein said computer provides a display of test results calculated from said measurement data.

17. The optical filter measuring system as recited in claim 9 wherein said light source means comprises a variable frequency laser.

18. The optical filter measuring system as recited in claim 9 wherein said computer comprises a program for analyzing, displaying and storing said measurement data for each of said optical filters.

19. A computer controlled system for measuring DWDM filters comprising:
an optical assembly having an optical axis which is angularly adjustable via a spherical shaped bearing surface pivoting about a fixed point located at said DWDM filters;
an extended area light detector positioned along said optical axis and spaced apart from said optical assembly for detecting a light beam after passing through one of said DWDM filters;
a variable frequency laser generator for providing said light beam to said optical assembly;
computer, connected to said optical assembly, said variable frequency laser generator and said reflected light detector, for controlling the measurement of each of said DWDM filters;
an electrical interface connected to said extended area light detector to provide optical power data to said computer and a computer program for analyzing, displaying and storing measurement data for each of said DWDM filters;
an xyz table controlled by said computer and disposed adjacent to said optical assembly for positioning each of said DWDM filters between said optical assembly and said extended area light detector for measurement; and
a vacuum pump connected to said optical assembly for raising each of said plurality of DWDM filters to contact an end of said optical assembly during said measurement.

20. The computer controlled system as recited in claim 19 wherein said optical assembly comprises a pair of linear displacement adjustment mechanisms preferably located at a right angle with respect to each other and controlled by said computer for adjusting said optical axis to maximize reflected light power.
